(19) United States
(12) Patent Application Publication
(10) Pub. No.: US 2008/0108515 A1
(43) Pub. Date: May 8, 2008

(54) Arrayed polynucleotides

(76) Inventors: Niall Anthony Gormley, Nr. Saffron Waldon (GB); Adrian Martin Horgan, Nr. Saffron Waldon (GB); Darren James Ellis, Nr. Saffron Waldon (GB); Jean-Ernest Sohna Sohna, Nr. Saffron Waldon (GB)

Correspondence Address: KLAUBER & JACKSON, 411 HACKENSACK AVENUE, HACKENSACK, NJ, 07601, US

(21) Appl. No.: 11/895,802

(22) Filed: Aug. 27, 2007

Related U.S. Application Data
(63) Continuation of application No. 10/588,613.

(30) Foreign Application Priority Data
Feb. 10, 2004 (GB) 0402895.7

(51) Int. Cl. C40B 50/06

(52) U.S. Cl. 506/26

(57) ABSTRACT

The present invention is concerned with methods of producing fabricated arrays comprising clusters of clonal copies of one or more target molecules. In particular the invention relates to methods comprising providing clonal copies of a single target molecule within a vesicle or on the surface of a solid support within a chamber defined by a vesicle in contact with a solid support to produce clonal copies thereof and immobilising the copies on the solid support.

The present invention is concerned with fabricated arrays and in particular with fabricated arrays of polynucleotide molecules and their use in genome analysis.

Advances in the study of molecules have been led, in part, by improvement in technologies used to characterise the molecules or their biological reactions. In particular, the study of nucleic acids, DNA and RNA, has benefited from developing technologies used for sequence analysis and the study of hybridisation events.

An example of the technologies that have improved the study of nucleic acids, is the development of fabricated arrays of immobilised nucleic acids. These arrays typically consist of a high-density matrix of polynucleotides immobilised onto a solid support material. Fodor et al., Trends in Biotechnology (1994) 12:19-26, describes ways of assembling the nucleic acid arrays using a chemically sensitised glass surface protected by a mask, but exposed at defined areas to allow attachment of suitably modified nucleotides. Typically, these arrays may be described as “many molecule” arrays, as distinct regions are formed on the solid support comprising a high density of one specific type of polynucleotide.

An alternative approach is described by Schena et al., Science (1995) 270:467-470, where samples of DNA are positioned at predetermined sites on a glass microscope slide by robotic micropipetting techniques. The DNA is attached to the glass surface along its entire length by non-covalent electrostatic interactions. However, although hybridisation with complementary DNA sequences can occur, this approach may not permit the DNA to be freely available for interacting with other components such as polymerase enzymes, DNA-binding proteins etc.

These arrays typically contain 10⁵ sites per cm² and at each site there are approximately one million copies of the same molecules.

An alternative to this approach is to create PCR derived “colonies” (also referred to as “polonies”) (Mitra R D & Church G M, Nucleic Acids Research; 1999, 27, WO 00/53812). DNA is cloned and amplified by performing the PCR reaction in a thin polyacrylamide film poured on a: glass microscope slide. The polyacrylamide matrix retards the diffusion of the DNA molecules so that the amplification products remain localised near their respective templates. Each polony had a radius in the range of 6-12.5 μm and allowed up to 5 million distinguishable polonies on a single slide. Forty cycles of PCR were employed and as many as 108 identical DNA molecules were present in each polony.

A solid phase DNA amplification approach has been described (Adessi, C et al.; Nucleic Acids Research; 2000; 28; WO 98/44151, WO 00/18957). Two different oligonucleotide primers were bound to a glass surface and these were able to bind and amplify DNA molecules present in the reaction mixture, with 30 cycles of PCR.

WO-A-96/27025 is a general disclosure of single molecule arrays. However, creating an assay derived from an array of single molecules makes major demands on the performance of the biochemistry employed. For example, the impact of poor fidelity or premature termination in a cyclical process can be damaging. This can act against the inherent simplicity and benefits of analysing single molecules. Furthermore, the application of single molecule arrays relies upon multiple cycles of detection in the array and absolute detection efficiency of the reporter group may be less than one. A cluster of copies derived from a single molecule would therefore be beneficial in certain applications, and yet may still achieve the benefits associated with single molecule arrays.

Therefore, it is an object of the present invention to provide an array and a method of producing it which array has fabricated thereon a cluster of copies of a target single molecule. The present inventors have now devised a new process that is particularly beneficial in the production of an array having such a clonal population.

### SUMMARY OF THE INVENTION

Therefore, according to the invention there is provided a method of producing a clustered array of one or more clonal copies of a single target molecule immobilised on a solid support, each cluster in said array being capable of resolution by optical microscopy, said method comprising providing clonal copies of a single target molecule within a vesicle or on the surface of a solid support within a chamber defined by a vesicle in contact with said solid support to produce clonal copies thereof and immobilising said copies on said solid support.

Thus, advantageously, the method according to the invention results in the production of a clustered array of clonal copies of a single target molecule, wherein each discrete cluster may be resolved by optical microscopy.

The single target molecule is preferably a nucleic acid molecule. Copies of the nucleic acid molecule may be produced by any known nucleic acid amplification technique, including both linear amplification methods and exponential amplification methods.

The present invention will now be further described. In the following passages different aspects of the invention are defined in more detail. Each aspect so defined may be combined with any other aspect or aspects unless clearly indicated to the contrary. In particular any feature indicated as being preferred or advantageous may be combined with any other feature or features indicated as being preferred or advantageous.

In one aspect of the invention copying of a single target molecule to produce clonal copies may be carried out on the surface of a solid support within a chamber defined by a vesicle in contact with said solid support. In this embodiment the clonal copies will be formed on the solid support, and thus immobilised thereon, concomitant with the copying step.

Therefore, according to a first aspect of the present invention there is provided a method of producing a clustered array of one or more clonal copies of a single target molecule, a cluster in said array being capable of resolution by optical microscopy, said method comprising,

a) providing a vesicle in contact with the surface of a solid support so as to define a chamber between said support and said vesicle and which chamber comprises a single target molecule including a functionality to effect immobilisation to the surface of said solid support,

b) copying said target molecule on the surface of said support to produce copies of said target molecule forming said cluster.

As would be appreciated by one of skill in the art, a number of methods or techniques are available to copy a single target molecule to produce copies thereof bound to the surface of a solid support. PCR may be utilised, for example, in the event that the molecule is a nucleic acid molecule where all of the necessary components thereof including polymerases and primer molecules and dNTP's are provided in the vesicle prior to or subsequent to said contacting step or are capable of being delivered thereto subsequent to it. Advantageously, where copying of a nucleic acid target molecule is carried out by PCR amplification using a pair of amplification primers, one of the pair of primers is attached to the solid support prior to amplification. During the amplification reaction immobilised primers will be extended to produce immobilised copies of the target nucleic acid molecule.

In one embodiment of this aspect of the invention the single target molecule may initially be provided in said vesicle. In this embodiment, the method includes the step of first contacting the vesicle with a solid surface to form the chamber and subsequently effecting immobilisation of the single target molecule to the surface.

Alternatively, in a second embodiment of this aspect of the invention, the single target molecule may first be provided on the surface and the vesicle subsequently contacted with said surface in such a manner so that the vesicle in contact with said surface defines said chamber between the vesicle and the surface and which chamber comprises the single target molecule. Accordingly, in this embodiment, prior to contacting the vesicle with the support, the vesicle may comprise all of the necessary components to effect copying of the single target molecule within the chamber formed on subsequent contact with the solid support to form said cluster of clonal copies.

In the this first aspect of the invention the target nucleic acid molecule may be immobilised on the solid support via a capture moiety which may itself be a nucleic acid molecule having a sequence of nucleotides complementary to those of the target molecule. Thus, the “functionality to effect immobilisation to the surface of said solid support” is a functionality capable of interacting with a complementary capture moiety attached to the surface of said solid support.

When the target molecule is a nucleic acid molecule, said functionality to effect immobilisation to the surface of said solid support may be a sequence of nucleotides in said nucleic acid molecule capable of hybridising to a nucleotide sequence in a complementary capture moiety, with the capture moiety itself being a polynucleotide molecule attached to the surface of the solid support. Typically the capture moiety will be attached to the solid support via a covalent chemical linkage, whereas the target molecule will be “immobilised” only via hybridisation between a sequence of nucleotides in the target molecule (typically 15-30, or 20-25 nucleotides) to a complementary nucleotide sequence in the capture moiety.

In the context of this application the term “hybrisidation” refers to sequence-specific binding between primer and target polynucleotides. Binding of a polynucleotide primer to its cognate sequence in a template/target polynucleotide can occur under typical conditions used for primer-template annealing in standard PCR. It will be appreciated that it is not strictly necessary to have 100% sequence identity in the first hybridisation step of a PCR reaction in order to achieve satisfactory hybridisation under such conditions, although this is generally preferred.

In a preferred embodiment the capture moiety may be an oligonucleotide primer (also referred to herein an amplification primer) which is capable of directing amplification of the target nucleic acid via any suitable nucleic acid amplification technique, in the presence of a suitable polymerase, dNTPs, buffer components and, depending on the chosen amplification technique, optionally a second type of amplification primer.

In the case of exponential amplification by PCR, one PCR primer may attached to the surface of the solid support. Attachment of the primer to the solid support (via any suitable covalent linkage of which many are known in the art) may take place prior to contact with the vesicles, and hence prior to amplification. Each vesicle will contain a single target molecule together with the enzymes and reagents necessary for PCR and a second PCR primer in free solution. If the vesicle permits exchange of small molecular weight components (e.g. dNTPs) with the bulk solution these may be present outside the vesicles. Following contact between the vesicles and the solid support to define chambers each including a single target molecule the reaction components are incubated under conditions that permit hybridisation between the target molecule (a single template strand thereof) and the PCR primer attached to the solid support. If the target molecule is double-stranded it may be necessary to include a denaturation step prior to hybridisation. The fact that the reaction is maintained within a closed chamber defined by the vesicle in contact with the support means that free strands (i.e. strands not attached to the support) generated during any denaturation steps will be contained. Once target and primer are hybridised the primer may be extended to produce a complementary copy of the target molecule. This complementary copy will be attached to the solid support by virtue of the attachment of primer to support. Exponential PCR amplification can then proceed using one attached primer and one primer in free solution. Alternatively it is possible to carry out linear amplification using only the immobilised primer. In either case attached complementary copies of the target (complementary to the template single strand hybridised in the first step) will be formed on the solid support as the amplification reaction progresses. Since amplification of each single target molecule is confined within the chamber defined by a vesicle in contact with the solid support, and is kept separate from each other amplification reaction the method leads to the production of a clustered array, each individual cluster being comprised of a plurality of immobilised clonal copies of a single target molecule.

The method according to the foregoing preferred embodiment of the invention can be used to generate a clustered array of clonal copies of multiple discrete target molecules via a pair of “universal” amplification primers, one of which is attached to the solid support, the other present in free solution within each vesicle, in excess over the target molecule. This can be done by including known adaptor sequences on the ends of target molecules to be “clustered” using the method. Each individual target nucleic acid molecule (viewed in single stranded form) will include a first known adaptor sequence at its 3′ end and a second known adaptor sequence at its 5′ end, wherein the first known adaptor sequence is capable of hybridising to the amplification primer attached to the surface of the solid support and the complement of the second known adaptor sequence is capable of hybridising to the amplification primer present in free solution. Adaptor molecules having suitable adaptor sequences can be attached to target molecules of known or unknown sequence using standard molecular biology techniques. “Universal” adaptors can be added to a population of different individual target molecules, such as for example random genome fragments, thus enabling each individual target molecule to be amplified using a common set of amplification primers, thus forming a clustered array, wherein each individual cluster is derived from a single target molecule.

Within this aspect of the invention it is also possible to perform surface-based linear amplification in order to generate clonal copies of a single target molecule, which may be single or double stranded. In this embodiment only a single primer species is required, which much be immobilised on the solid support. The target molecule (or on denatured strand thereof in the case of a double-stranded target) is annealed to the primer bound on the surface of the support and a copy is generated via simple primer extension. Following a further denaturation step the target strand will be free to anneal to a further primer. Successive cycles of denaturation, annealing and extension will result in production of a cluster of clonal copies.

In a second aspect of the invention, the vesicles themselves may already be provided with the copies of said single target molecules. Copying of a single target molecule may take place within a vesicle and the copies subsequently immobilised on the solid support in a separate immobilisation/capture step.

Accordingly in this second aspect of the invention there is provided a method of producing a clustered array of one or more clonal copies of a single target molecule, a cluster in said array being capable of resolution by optical microscopy, said method comprising,

a) providing at least one vesicle defining an enclosed chamber therein, said chamber including said single target molecule and one or more copies thereof,

b) contacting said vesicle with the surface of a solid support to effect localised immobilisation of the target molecule and the copies thereof to the surface of said support, said single target molecule and copies thereof including a functionality to effect said immobilisation to the surface of said solid support.

In this aspect of the invention the single target molecule is again preferably a nucleic acid molecule. Copies may be produced via linear or exponential amplification within the vesicles using any suitable nucleic acid amplification technique.

Preferably, the copies of the target molecule, according to this second aspect of the invention, are capable of being attached to the solid support via a functionality which may be capable of attachment itself or alternatively may be capable of interacting with a complementary capture moiety having means to effect attachment to the surface of the support. Therefore, the target molecule and/or the copies thereof may include a functionality that permits attachment either directly to the surface of the support or indirectly via a capture moiety.

In one embodiment, when the target molecule and the copies thereof are nucleic acid molecules, the functionality may comprise a sequence of nucleotides complementary to a molecule having another sequence of nucleotides, which may itself be immobilised on the surface, or provided in the vesicle and may be capable of attachment to the surface. In another embodiment, said functionality may comprise a linking moiety to which each of said target molecules and/or said copies may be attached. Where the target molecule is a nucleic acid molecule, preferably the copies of said nucleic acid molecule comprise complementary copies of the molecule.

Thus, the copies of the target nucleic acid molecule present within the vesicle may, following contact between the vesicle and the solid support, be immobilised via a capture moiety which may itself be a nucleic acid molecule having a sequence of nucleotides complementary to a nucleotide sequence in the copies of the target molecule. In one embodiment of the invention, the capture moiety may comprise a hairpin oligonucleotide, for example, and in this embodiment the hairpin oligonucleotide includes a known nucleic acid sequence that is complementary to a sequence on the copies of the target nucleic acid molecule so that it is/they are capable of hybridising thereto. The hairpin oligonucleotide itself therefore may also comprise means to effect immobilisation or attachment to the solid support. Thus, the target nucleic acid may itself include an adaptor molecule of known sequence, the complementary sequence of which is complementary to a sequence on the hairpin oligonucleotide. Copies of the target nucleic acid will thus be able to hybridise to the hairpin oligonucleotide including the complementary sequence.

The complementary sequence on the hairpin may advantageously function as a primer for a polymerase based sequencing reaction, enabling sequencing of the copies. Thus, the adaptor molecule on said target nucleic acid molecule may be provided on its 5′ end (when the target molecule is in single stranded form), such that a complementary sequence is present at the 3′ end of complementary copies of said target nucleic acid. The 3′ end of said hairpin may therefore include a sequence which corresponds to a sequence of the adaptor molecule on the 5′ end of the target molecule, or alternatively may be complementary to a sequence on the 3′ end of the complementary copy.

The target nucleic acid molecule or its copies may also comprise another adaptor molecule, again of known sequence, at the 3′ end of the target molecule (when the target molecule is in single stranded form). This sequence will be different from that of the adaptor molecule located at the 5′ end and similarly for the copies thereof. This 3′ adaptor sequence may provide a binding site for an amplification primer, permitting linear amplification of a single template strand of the target molecule.

When the capture moiety comprises a hairpin oligonucleotide, a ligation reagent such as a ligase enzyme may be used to ligate the target molecule to the hairpin oligonucleotide. The hairpin oligonucleotide should, therefore, include a phosphate moiety to ensure ligation by the ligase enzyme at its 5′ end.

In this second aspect of the invention, production of the copies of said target nucleic acid molecule can occur within the vesicle itself prior to contacting the vesicle with the solid support. Copying can be carried out via any suitable linear or exponential nucleic acid amplification reaction. Therefore, the vesicle may also comprise a polymerase enzyme, which is preferably a thermostable polymerase enzyme, in addition to a primer that is complementary to a sequence on the 3′ end of said target molecule. Preferably said 3′ end sequence on the target nucleic acid is an adaptor molecule at the 3′ end of said target nucleic acid molecule. Nucleotides may also be included in the vesicle or, for example, may be provided externally where for example, the vesicle includes a membrane or shell that is semi-permeable or selective to allow diffusion of the nucleotides into the vesicle. Such a membrane, therefore, will be permeable to the nucleotides to allow their diffusion into the vesicle but prevent the diffusion of the single target molecule and the copies therefrom.

When the capture moiety comprises a hairpin oligonucleotide or another suitable nucleic acid having a sequence complementary to a sequence in the copies of the target molecule, it may be deposited on the surface of the support at a density corresponding to that of the final clustered array. Once the copies of the target nucleic acid molecule are produced and following attachment to the solid surface via the complementary sequences on the nucleic acid molecule of the capture moiety on the surface of said solid support, the clustered array will be generated. In order to form a clustered array it is essential that each clonal population of copies of a given target molecule are kept separate from other clonal populations of copies of different target molecules until such time as the copies are attached to the surface of the solid support to form discrete clusters. In this second aspect of the invention this can be achieved by ensuring that attachment of copies produced in vesicles in free solution to the solid support take place within a chamber defined by a vesicle and the solid support following contact between vesicle and support. The copies contained within individual vesicles must not be allowed to mix with those in other vesicles prior to attachment to the support.

In a third aspect of the invention, the vesicles may include a linking molecule to link the copies of said target molecule together prior to their transfer to the surface to form the cluster. This embodiment advantageously obviates the necessity to fuse the vesicles to the solid surface to produce the array, the method allowing maintenance of the copies in the form of a clustered array by virtue of the linking molecule. However, it may still be desirable in certain circumstances to fuse the vesicle to the solid support. Therefore, according to this third aspect of the invention, there is provided a method of producing a clustered array of one or more clonal copies of a single target molecule, each cluster in said array being capable of resolution by optical microscopy, the method comprising,

a) providing at least one vesicle defining an enclosed chamber therein and one or more copies of said single target molecule within said vesicle,

said vesicle comprising a linking molecule for linking said copies together in said vesicle, and

b) applying said linked copies of said target molecule to a solid surface to form an array of clustered arrays of said copies, said linking molecule comprising a functionality to effect attachment to the surface of said support.

In one embodiment, when the primers and appropriate reagents are provided in said vesicle for polymerase based amplification, a linking molecule is provided therein to link the copies of said target nucleic acid. In an even more preferred embodiment the primers may be provided on the linking molecule.

The linking moiety according to the invention may comprise for example a dendrimeric molecule, which may include a plurality of one of the amplification primers for said target molecule attached thereon. Accordingly, following amplification of the template target nucleic acid within said vesicle one of the copies of said nucleic acid molecule will be attached to the dendrimeric molecule, which may itself be functionalised for attachment to the solid surface either directly or indirectly via an intermediate molecule. Thus, advantageously, a linking moiety according to the invention may be utilised within the vesicles to link the copies of the nucleic acid molecules together for application to the surface to form the array. Alternatively, the vesicles may be broken up prior to attachment to the surface and the contents therein extracted into an aqueous solution, which is then applied to the surface. In one embodiment of this aspect of the invention, the nucleic acid molecule copy coupled to the dendrimeric molecule may include a functionality that allows it to be coupled to the surface. For example, the surface may include a nucleotide sequence that is the same as or corresponds to that contained on the 5′ end of the target DNA molecule to be copied. The 3′ end of the complementary copy of the target DNA may then hybridise to said nucleotide molecule to attach it to said support. In this embodiment the nucleic acid immobilised on the surface constitutes the capture moiety. Alternatively, the linking molecule itself may include the functionality to attach it to the surface.

In an alternative embodiment, the linking molecule may be activated within the vesicle to link the products of the amplification reaction together in a cluster. For example, a binding agent, such as acrylamide and a polymerisation initiator such as ammonium persulfate (APS) and tetraethylmethylene diamine (TEMED) may be used. Therefore, the amplification primers may contain an acrylamide moiety. The TEMED may then be added to the vesicles or the suspension containing the vesicles and which diffuses through the bulk phase to the interior of the vesicles where it may initiate the polymerisation reaction. Alternatively, polymerisation agents may be utilised that are activated following irradiation by light in which case applying light at an appropriate wavelength will link the DNA molecules together.

In one embodiment of each of the aforementioned aspects of the invention, the vesicle may comprise an isolated chamber in a bulk phase, whose interface with the bulk phase prevents any exchange of the single target molecule or the copies thereof in the, preferably aqueous, chamber with the bulk phase. Thus, advantageously, the vesicle may be constructed or formed from any material that prevents exchange of the single target molecule or copies thereof with neighbouring vesicles and, preferably, which remains thermally stable during the performance of the method. One way to achieve this is to create a small aqueous chamber. A number of embodiments may therefore be envisaged in this respect. For example, the vesicle may be in the form of discrete ordered liposomes or microcapsules or droplets of water emulsified in oil. As would be known to those of skill in the art, a variety of lipophilic agents may be used, for example, lipids, both natural and artificial with a variety of polar head groups, and different numbers of lipophilic tails of varying lengths and saturation or oils, liquid hydrocarbons and detergents/surfactants. Alternatively the vesicle may be formed from a polyelectrolyte nanoshell. One of the advantages of utilising microcapsules is that they can easily be recovered, for example, by filtration, centrifugation, precipitation or the like and they can be stored in the dry state as a free flowing powder.

The vesicles may therefore be subjected to a microencapsulation process, such as for example by a process of coacervation, whereby a water in oil droplet containing said target molecule is provided with a suitable water soluble polymer colloid that is essentially immiscible with the continuous oil phase.

In all of the aforementioned embodiments, it is preferable that the vesicle comprises an aqueous core which is particularly beneficial in the application of the current method to production of nucleic acid arrays.

The vesicle itself also forms part of the present invention. Therefore, in accordance with a further aspect of the invention, there is also provided a vesicle for use in producing a clustered array of one or more clonal copies of a single target molecule, said vesicle comprising an enclosed chamber therein comprising said single target molecule and/or copies thereof, and which vesicle is formed from an isolated chamber in a bulk phase, whose interface with the bulk phase prevents exchange of the contents of the aqueous chamber with the bulk phase. Preferably, all of the necessary components to copy the target nucleic acid molecule, including for example primers specific for the 3′ end of the target nucleic acid, a polymerase and nucleotides, are already maintained within the vesicles. The precise nature of these components may vary depending on the chosen amplification method. Additionally, one or more linking molecules may also be provided to link the copies of the target nucleic acid molecules together, for attachment to the surface. In one embodiment, amplification or copying of the target nucleic acid molecules may be controllable by maintaining the temperature of the vesicles at a temperature to inhibit enzyme activity in which case the vesicles can be stored at such an enzyme inhibitory temperature. When it is desired to produce the array, the temperature is raised and the method as hereinbefore described may be carried out. Therefore, by maintaining the temperature of the vesicles at a suitably low temperature, for example, enzyme activity of, for example, the thermostable polymerase enzyme, may be inhibited thereby preventing any amplification occurring.

A plurality of the vesicles may also be provided in a kit for use in a method of producing a clustered array, which kit comprises a plurality of vesicles as defined herein and a solid support for contacting with said vesicles. Within such kits the vesicles may be stored at low temperature in order to inhibit enzyme activity. Kits according to the invention may comprise vesicles pre-loaded with reagents such as primers, enzymes, buffer components etc. Other kits may comprise reagents which are capable of forming loaded vesicles according to the invention under certain physical conditions, or when mixed with other components, rather than a supply of complete vesicles. Such kits may comprise, for example, supplies of lipophilic material capable of forming the vesicles together with one or more reagent components to be loaded into the vesicles.

Kits according to the invention may include one or more amplification primers which permit amplification of one or more target nucleic acid molecules, especially target molecules modified by the addition of one or more adaptor sequences in accordance with the invention. Depending on the chosen amplification method, primers may be supplied in the kit pre-loaded into vesicles, or ready for loading into vesicles, or immobilised on the solid support, or may include a functionality which enables immobilisation on a suitably functionalised solid support before or after amplification, or any suitable combination of the foregoing. Kits may also include one or more adaptor molecules which can be added to target molecules in order to permit amplification using a particular primer or primers. The kits may also include a capture moiety according to the invention which may be attached to the support or may include a functionality which permits such attachment. The kits may also include supplies of enzymes, buffers, dNTPS etc required for a particular amplification reaction, either pre-loaded in vesicles or ready for loading. Kits according to the invention may include any combination of the above-described components, optionally with instructions for use.

The present invention may be more clearly understood from the following detailed description with reference to the accompanying drawings, wherein:

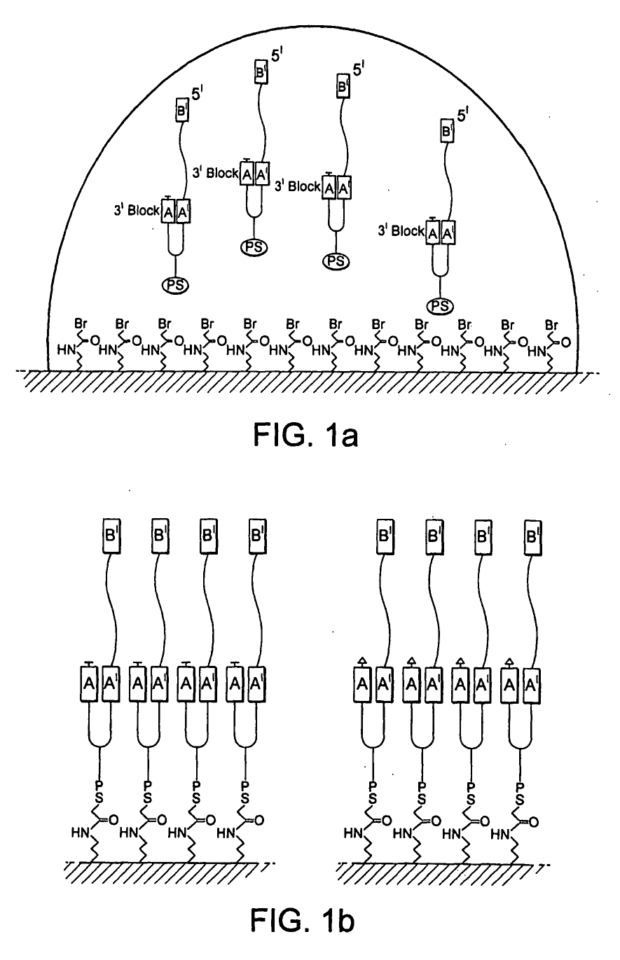

FIG. 1 is an illustration of a vesicle utilised in accordance with the invention fused to a solid support to define a chamber.

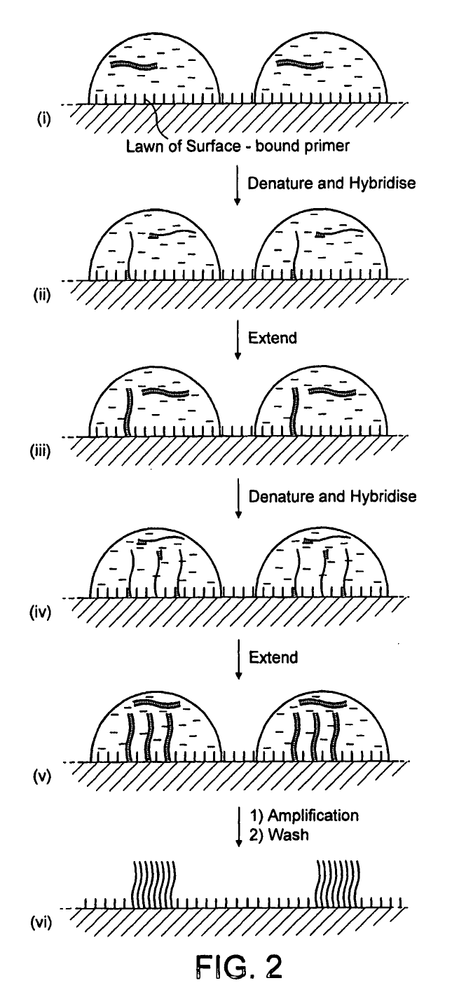

FIG. 2 is an illustration of the steps of one embodiment of the method of the invention utilising surface-based amplification within a chambers defined by vesicles on a solid support to produce a clustered array.

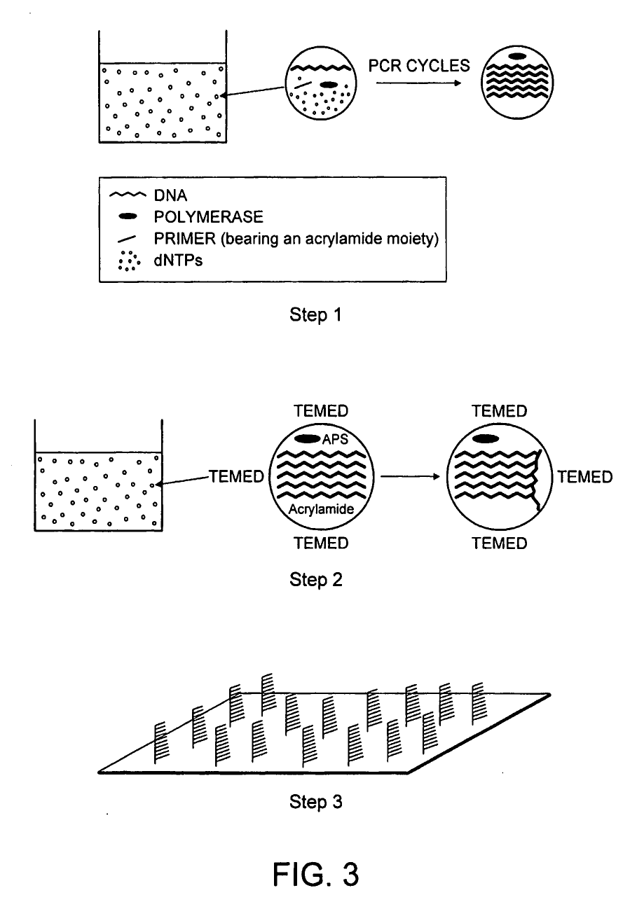

FIG. 3 is an illustration of the steps of another embodiment of the method of the invention employing a linking molecule.

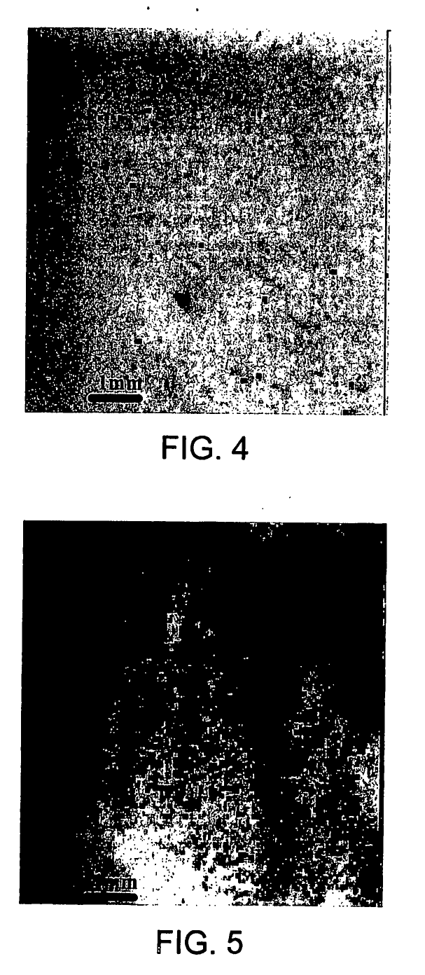

FIGS. 4 and 5 are fluorescent microarray scanned images of slides covalently coupled with DNA from an emulsion of discrete vesicles. FIG. 5 shows a slide coupled with fluorescent labelled DNA containing a 5′ phosphothioate group. FIG. 4 is a negative control in which slides were coupled with labelled DNA containing a 5′ phosphate group.

### DETAILED DESCRIPTION OF THE INVENTION

As set out above and in the example provided, the present invention is concerned with a method of producing a clustered array of one or more clonal copies of a single target molecule. As used herein, the term “clustered array” refers to a population of copies, complementary or otherwise, of a single molecule, for example, a polynucleotide. A plurality of the copies of the target molecule may be distributed over the solid support and each cluster will correspond only to a specific type of molecule or species. The clusters are distributed over the array at a distance from one another sufficient to permit resolution of each discrete cluster.

The method of the invention comprises providing at least one, but preferably a plurality, of vesicles that define an enclosed chamber therein and within which is located a single target molecule. The target molecule may be any molecule which is desired to be copied but is preferably a nucleic acid, such as a polynucleotide. In one embodiment, the target nucleic acid may be derived from genomic DNA that has been subjected to fragmentation. These vesicles may be contacted with the surface of a solid support to effect immobilisation of the molecule to the solid support by virtue of a chemical or other suitable functionality thereon that effects immobilisation itself either directly to the surface or alternatively indirectly by virtue of a complementary functionality attached or capable of being attached to the support. As would be apparent to the skilled practitioner, the step of contacting said support may be achieved in a passive or active manner to achieve fusion of said vesicle with said support. Active means include directed or targeted contact utilising, for example, complementary functionalities on the surfaces of both said support and said vesicle or complementary electrostatic charges. The surface fusion event may occur passively following contact of the vesicle with the solid support, for example in the case of aqueous contents fusing to a hydrophilic surface site. Other ways include, evaporation, chemical extraction of the lipids, osmotic shock or the like.

Many suitable vesicles may be utilised in the performance of the present invention. Generally, such vesicles may be any vesicle of the type having an isolated chamber in a bulk phase whose interface with the bulk phase prevents exchange of the contents therein with the bulk phase and also any other vesicles in the bulk phase. However, semi-permeable vesicles may also be used that permit a limited degree of diffusion into the vesicle. For example, it may be possible to deliver nucleotides to the interior of the vesicle by incubating the vesicles in a solution of the nucleotides when the material used to form the vesicle allows diffusion of the nucleotides across the membrane but which also prevent diffusion of the larger single target molecules or the copies thereacross. Therefore, to maintain the individuality of each of the single target molecules within the vesicles and the subsequent cluster, it is particularly important that no or substantially no content exchange occurs between vesicles which thus ensures the clonal nature of the molecule once copied. The vesicle may, therefore, be formed from droplets of water emulsified in oil. Alternatively, the vesicle may be formed from a liposome or a polyeletrolyte nanoshell. In all such embodiments it is highly preferable that the vesicle comprises an aqueous core. This is particularly beneficial when the target molecule is a nucleic acid molecule, and which results in the production of an array of nucleic acid molecules in clusters on the array.

The vesicles may be further subjected to a microencapsulation process, such as, by a process of coacervation for example, whereby a water in oil droplet containing said target molecule is provided with a suitable water soluble polymer colloid that is essentially immiscible with the continuous oil phase. If one starts with a solution of a colloid(/polymer) in an appropriate solvent, then according to the nature of the colloid, various changes can bring about a reduction of the solubility of the colloid. As a result of this reduction a large part of the colloid can be separated out into a new phase. Generally, the core material used in the coacervate must be compatible with the recipient colloid/polymer and be insoluble (or scarcely soluble) in the coacervation medium. The original one phase system becomes two phases. One is rich and the other is poor in colloid concentration. Coacervation may be initiated in a number of different ways. Examples include changing the temperature, changing the pH or adding a second substance such as a concentrated aqueous ionic salt solution or a non-solvent. As the coacervate forms, it must wet the suspended core particles or core droplets and coalesce into a continuous coating for the process of microencapsulation to occur. The final step for microencapsulation is the hardening of the coacervate wall and the isolation of the microcapsules, usually the most difficult step in the total process.

The coacervation procedure may be simple or complex. Simple coacervation involves only one type of polymer with an addition of strongly hydrophilic agents to the colloidal solution whereas complex coacervation uses two or more types of polymer.

Heating of the mixture causes coacervation to occur thus hardening at the interface of the water in oil droplet to create a colloidally rich polymer shell. Advantageously, these particles may be separated by phase separation. This is particularly advantageous because the polymer shell may be designed to be permeable to certain compounds, for example nucleotides. In this example, the polymer shell surrounding the aqueous droplet may then include a target polynucleotide, together with the appropriate primer and polymerase, and the PCR reaction may be performed in aqueous solvent containing the nucleotides, wherein the polymer shell is designed such as to be permeable to the nucleotides whilst maintaining the polymerase and other molecules inside. Alternatively, the PCR reaction may be performed within the aqueous droplet emulsified in the oil, which is then subsequently subjected to coacervation or other suitable methods to form the shell. The microcapsules may then be stored in the dry state or in an appropriate solvent for subsequent use. Once deposited on the surface, the shell may be removed to deposit the contents therein on the surface to form the clustered array.

As used herein, the term “single target molecule” refers to one single molecule rather than a single type of molecule. In the context of a nucleic acid molecule, this may be a polymeric molecule of a nucleic acid sequence. Thus, an array feature or address corresponding to a single target nucleic acid molecule or polynucleotide consists of only one such molecule in the vesicle. The addresses in the clustered array in the present invention are intended to be populated by only one type of polynucleotide molecule, such as complementary copied strands which are capable of interrogation.

“Solid support”, as used herein, refers to the material to which the target polynucleotides and complementary molecules are attached. Suitable solid supports are available commercially, and will be apparent to the skilled person. The supports can be manufactured from materials such as glass, ceramics, silica and silicon. Supports with a gold surface may also be used. The supports usually comprise a flat (planar) surface, or at least a structure in which the polynucleotides to be interrogated are in approximately the same plane. Alternatively, the solid support can be non-planar, e.g., a microbead. Any suitable size may be used. For example, the supports might be on the order of 1-10 cm in each direction.

The term “resolvable by optical microscopy” is used herein to indicate that, when visualised, it is possible to distinguish between discrete clusters on the array (e.g. clusters of complementary copies) using optical microscopy methods available in the art. Visualisation may be effected by the use of reporter labels, e.g., fluorophores, the signal of which is resolved at the level of the cluster.

As used herein, the term “interrogation” means contacting one or more of the polynucleotide molecules on the array, for example complementary copies of the target polynucleotides, with another molecule, e.g., a polymerase, a nucleoside triphosphate or a complementary nucleic acid sequence, wherein the physical interaction provides information regarding a characteristic of the arrayed target polynucleotide. The contacting can involve covalent or non-covalent interactions with the other molecule. As used herein, “information regarding a characteristic” means information regarding the sequence of one or more nucleotides in the target polynucleotide, the length of the target polynucleotide, the base composition of the target polynucleotide, the Tₘ of the target polynucleotide, the presence of a specific binding site for a polypeptide or other molecule, the presence of an adduct or modified nucleotide, or the three-dimensional structure of the polynucleotide.

The target molecules contained in the vesicles used in accordance with the method of the invention, may be copied in a surface dependent or independent manner. The molecule may be copied within the vesicle using an appropriate method such as PCR or the like. For example, in one embodiment the target nucleic acid may be a target locus from a fragmented genome. In this embodiment the vesicle may beneficially be used to amplify said locus so as to, for example, detect for genetic variation in a population. In this embodiment PCR primers can be used in an amplification step to amplify the locus of interest, e.g. which may contain an SNP. Once the PCR amplified fragments have been deposited on the surface of the support by virtue of an appropriate functionality on said primers, the genotype at the locus of interest may be identified by, for example, contacting the support with labelled oligonucleotide probes to identify the presence of said locus.

When the single target molecule is a nucleic acid molecule copies may be produced using any suitable nucleic acid amplification technique. In a preferred aspect of the invention, when the molecule comprises a nucleic acid molecule, the copies comprise complementary copies of the target nucleic acid molecule. Thus, in any given vesicle there may be included either a single copy of the target nucleic acid molecule together with a plurality of complementary copies or both. In this regard, all of the components or factors necessary to produce said complementary copies may be included in the vesicle. Generally, such components or factors include an appropriate polymerase enzyme together with a suitable primer capable of initiating the production of a complementary strand, in the presence of appropriate dNTP molecules. Complementary copies of a single target molecule can be produced by a linear amplification reaction using a single primer species complementary to a sequence on the single target molecule. In this regard the target nucleic acid molecule may include, and the method may comprise as a further step the inclusion of, an adaptor molecule at the 3′ end thereof having a known sequence against which a complementary primer may be designed to initiate production of the complementary strand following binding of the polymerase thereto. Many appropriate polymerase enzymes are known in the art including Taq polymerase, T7 RNA polymerase and the like. The target single molecule could also be amplified by a standard PCR reaction resulting in the generation of amplified “sense” and “antisense” strands. It is possible to selectively immobilise only one type of strands, e.g. only the complementary copies, to form clusters of clonal copies. By way of example, standard PCR can be carried out using two amplification primers, only one of which comprises a functionality which permits attachment of the copied strand incorporating this primer to the solid support. This embodiment will be further understood with reference to the accompanying non-limiting Example 1.

In certain embodiments of the invention the generation of said complementary copies may be carried out on the surface of the solid support in which case the generation of the complementary copies does not occur until contact between the vesicle and the surface of the support takes place. The vesicle may be designed of a suitable material such that upon contact with the surface of the solid support, fusion of the support and the vesicle is allowed to occur either passively by said contacting step or by other means such as for example evaporation, chemical extraction of lipids or the like to form a chamber between solid support and said vesicle. Fusion of the vesicle with the surface of the support therefore permits the contents of the vesicle to have access to the surface of the support for interaction therewith. Suitable primers may be provided which are immobilised to the surface and which are capable of initiating the production of complementary copies of said nucleic acid molecule in the presence of said polymerase and dNTP molecules. Thus, the vesicle may be designed or formed from a material that is capable of fusing to said solid support to form a reaction chamber between the support and the vesicle.

As aforementioned, the target molecule or copies thereof are capable of being attached to the solid support by virtue of a chemical or other functionality thereon, such as a functionality that can interact with a complementary capture moiety to effect attachment to the surface of the support following contact (or fusion) of the vesicle with the surface of the solid support, or a functionality which permits direct chemical coupling of the copies to a functional group on the surface of the support. When the target molecule is a nucleic acid molecule, the capture moiety may be a sequence of nucleotides that is capable of hybridising with a complementary sequence on a complementary copy of the target molecule. The capture moiety may itself be provided on the surface of the support or may be included in the vesicle and thus may itself include means for attachment to the surface of the support. In this embodiment, the target molecule may include an adaptor of known sequence, the complementary copy of which can hybridise to the sequence of nucleotides on the capture moiety, which adaptor molecule or sequence may be positioned at the 5′ end of the nucleic acid. Thus, advantageously, the capture moiety may itself act as a primer for surface based amplification of the target nucleic acid.

In one embodiment a linking molecule may be provided in the vesicle, which functions to link the nucleic acid molecules together in the vesicle. In this aspect the vesicles need not be contacted with the surface to form the array. Instead the vesicles can be broken up to release their contents into an aqueous solution which may be contacted with the surface of the support that will form the array. The linking molecule may for example, comprise a dendrimeric molecule having attached thereto the primers to be used for the polymerase based amplification of the target nucleic acid molecule within the vesicle. The capture moiety in this embodiment may comprise a nucleic acid sequence which can be immobilised to the surface of the support. The nucleic acid sequence of the capture moiety for attachment on the support may have a sequence corresponding to the 5′ end of the target molecule. In this instance, the complementary copy of the target nucleic acid molecule produced by a polymerase based amplification will have at its 3′ end a sequence complementary to that of the nucleic acid sequence of the capture moiety. As aforementioned, the nucleic acid sequence of the capture moiety enabling capture of copies of the target molecule onto the solid support may, in certain embodiments of the invention, be included on a hairpin oligonucleotide that may be attachable to the support.

The linking molecule or moiety may comprise a chemical functionality on each of the primers in said vesicle that act as a polymerisation initiator and which initiator may be activated with the vesicle, such as for example acrylamide on each of said primers, in the presence of APS and TEMED.

According to the invention, reference to “hairpin oligonucleotide” means a single-stranded nucleic acid molecule which is capable of forming a hairpin, that is, a nucleic acid molecule whose sequence contains a region of internal self-complementarity enabling the formation of an intramolecular duplex or self-hybrid. “Region of self-complementarity” refers to self-complementarity over a region of 4 to 100 base pairs. When not self-hybridized, the hairpin oligonucleotide can be 8 to 200 base pairs, preferably 10 to 30 base pairs in length. By saying that the hairpin oligonucleotide is a “self-hybrid”, or that the hairpin oligonucleotide has “self-hybridized”, means that the hairpin oligonucleotide has been exposed to conditions that allow its regions of self-complementarity to hybridize to each other, forming a double-stranded nucleic acid molecule with a loop structure at one end and an exposed 3′ and 5′ end at the other.

In one embodiment, the hairpin oligonucleotide is synthesized in a contiguous fashion but is not made up entirely of DNA, rather the ends of the molecule comprise DNA bases that are self-complementary and can thus form an intramolecular duplex, while the middle of the molecule includes one or more non-nucleic acid molecules. An example of such a hairpin nucleic acid molecule would be Nu-Nu-Nu-Nu-Nu-LM-Nc-Nc-Nc-Nc-Nc, where “Nu” is a particular nucleotide, “Nc” is the nucleotide complementary to Nu, and “LM” is the linker moiety linking the two strands, e.g., hexaethylene glycol (HEG) or polyethylene glycol (PEG). The non-nucleic acid molecule(s) can be linker moieties for linking the two nucleic acids together (the two nucleic acid halves of the overall hairpin nucleic acid molecule), and can also be used to attach the overall hairpin nucleic acid molecule to the substrate. Alternatively, the non-nucleic acid molecule(s) can be intermediate molecules which are in turn attached to linker moieties used for attaching the overall hairpin nucleic acid to the solid substrate.

In another embodiment, the hairpin oligonucleotide is composed of two separate but complementary nucleic acid strands that are hybridized together to form an intermolecular duplex, and are then covalently linked together. The linkage can be accomplished by chemical crosslinking of the two strands, attaching both strands to one or more intercalators or chemical crosslinkers, etc.

In a further embodiment of the invention, the hairpin molecule includes a 3′ overhang which is taken to mean that at the 3′ end of the hairpin molecule, there is provided a sequence of nucleotides which do not hybridise to a complementary region.

In a still further embodiment the 3′ end of the hairpin includes a 3′ block. The adaptor molecule on the 5′ end of the target nucleic acid molecule preferably corresponds to a sequence on the 3′ end of the hairpin oligonucleotide. Therefore, once the copy of the target nucleic acid molecule including a sequence at its 3′ end complementary to said 5′ adaptor molecule is brought into contact with said hairpin molecule, the 3′ sequence of said complementary copy will hybridise to its complementary sequence on the 3′ overhanging sequence of the hairpin. The hairpin oligonucleotide also preferably includes a phosphate moiety at the 5′ terminus thereof so that the 3′ end of the copy of the target nucleic acid molecule can be ligated thereto in the presence of an appropriate ligase enzyme. Accordingly, the hairpin oligonucleotide should be designed such that upon hybridisation of the 3′ end of the copy of the target polynucleotide to its complementary sequence on the 3′ of the hairpin, the phosphate moiety on the 5′ end is sufficiently proximal to the 3′ end of the copy of the target nucleic acid molecule so as to be capable of undergoing a ligation reaction. Once the stabilised ligation product is generated, the sequence at the 3′ end of the hairpin complementary to that of the 3′ end of the copy of the target polynucleotide can serve as a primer for a subsequent polymerase based sequencing reaction to identify the sequence of the target nucleic acid molecule.

The target nucleic acid molecule used in accordance with the invention may typically be DNA or RNA, although nucleic acid mimics, e.g., PNA or 2′-O-methyl-RNA, are within the scope of the invention. The target nucleic acid molecule may comprise natural and/or natural bases and natural and/or non-natural backbone linkages or any combination thereof. Reference herein to a target nucleic acid molecule may also include a target polynucleotide, for example a specific locus from a genomic DNA fragment.

Immobilisation of polynucleotides, such as amplification primers or hairpin oligonucleotides, may be by specific covalent or non-covalent interactions. In the present invention, biotin may be used to immobilise the primers or hairpin oligonucleotides to a streptavidin coated solid support. immobilisation may also be carried out using covalent means such as amino or thiol oligonucleotides onto activated carboxy, maleimide or other suitably reactive surfaces.

A first step in the fabrication of the arrays will usually be to functionalise the surface of the solid support, making it suitable for attachment of the molecules or polynucleotides. Biotinylated albumins (BSA) can form a stable attachment of biotin groups by physisorption of the protein onto surfaces. Covalent modification can be performed using silanes, which have been used to attach molecules to a solid support, usually a glass slide. A mixture of tetraethoxysilane and triethoxy-bromoacetamidopropyl-silane (e.g. in a ratio of 1:100) can be used to functionalised glass slides which permit attachment of molecules (e.g. nucleic acids) including a thiophosphate or phosphorothioate functionality. Biotin molecules can be attached to surfaces using appropriately reactive species such as biotin-PEG-succinimidyl ester which reacts with an amino surface. The vesicles can then be brought into contact with the functionalised solid support, to form the arrays.

In an alternative embodiment, the support surface may be treated with molecules having different functional groups, one of the functional groups being intended to react specifically with particular molecules to be immobilised on the surface. Controlling the concentration of each functional group provides a convenient way to control the densities of the hairpin molecules/amplification primers.

Suitable functional groups will be apparent to the skilled person. For example, suitable groups include: amines, acids, esters, activated acids, acid halides, alcohols, thiols, disulfides, olefins, dienes, and halogenated electrophiles.

Preferably the functional groups will be electrophilic and thus capable of reacting with complementary nucleophilic functional groups attached to the hairpin molecule or target nucleic acids. Preferred nucleophilic functional groups attached to the hairpin molecule or target nucleic acids are thiophosphate and phosphorothioate moieties, particularly phosphorothioate moieties.

Preferably, the electrophilic functional groups will be acids, esters, activated acids, acid halides and halogenated electrophiles. A particularly preferred group of molecules with which the support surface may be treated are silanes of the general formula RₙSiX₍₄₋ₙ₎ (wherein R is an inert moiety that is displayed on the surface of the solid support, n is an integer from 1-4 and X is or comprises a reactive leaving group, such as a halide (e.g. Cl, Br) or alkoxide (e.g. X may be a C₁₋₆ alkoxide). An example of such an X moiety which comprises a reactive leaving group is haloacetamido alkyl (e.g. of formula (CH₂)ₘ N(H)C(O)Y, wherein m is an integer of from 1 to 20, preferably 3 to 10, and Y is a halogen such as bromine, chlorine or iodine, preferably bromine). Particularly preferred silanes for use in this invention, so as to produce appropriately modified surfaces, include silanes such as tetraethoxysilane, triethoxymethylsilane, diethoxydimethylsilane, glycidoxypropyltriethoxysilane, or triethoxybromoacetamidopropyl silane although many other suitable examples will be apparent to the skilled person.

Preferably mixtures of silanes are employed, as illustrated in the examples below. Mixtures of tetraethoxysilane and triethoxybromoacetamidopropyl silane are particularly preferred. By modifying the quantities of silanes used, control may be achieved over the density of hairpins/target nucleic acids achieved on the surface.

The clustered (e.g. complementary) copies of the target nucleic acid molecule immobilised onto the surface of the solid support should be capable of being resolved at from other discrete clusters by optical means. This means that, within the resolvable area of the particular imaging device used, there must be one or more distinct signals, each representing either one discrete cluster. Thus, each discrete cluster is individually resolvable and detectable. Typically, the clustered polynucleotides of the array are resolved using a single molecule fluorescence microscope equipped with a sensitive detector, e.g., a charge-coupled device (CCD). Each cluster of the array may be imaged simultaneously or, by scanning the array, a fast sequential analysis can be performed. While the density of the clustered arrays is not critical, it must be such as to render the clusters individually resolvable as hereinbefore described. Preferably, however, the clusters are provided in the range of 10⁶ to 10⁹ clusters per cm² and more preferably 10⁶ to 10⁷ clusters/cm².

Once formed the clustered arrays may be used in procedures to determine the sequence of the target nucleic acid molecule or polynucleotide. In particular, the arrays may be used in conventional assays which rely on the detection of fluorescent labels to obtain information on the arrayed polynucleotides. The arrays are particularly suitable for use in multi-step assays where the loss of synchronisation in the steps was previously regarded as a limitation to the use of arrays. The arrays may be used in conventional techniques for obtaining genetic sequence information. Many of these techniques rely on the stepwise identification of suitably labelled nucleotides, referred to in U.S. Pat. No. 5,654,413 as “single base” sequencing methods.

In an embodiment of the invention, the sequence(s) of the target polynucleotide may be determined in a similar manner to that described in U.S. Pat. No. 5,654,413, by detecting the incorporation of nucleotides into the nascent strand through the detection of a fluorescent label attached to the incorporated nucleotide in the growing strand which has as its template the complementary copy of the target nucleic acid. Any suitable polynucleotide primer capable of hybridising to the complementary copies to be sequence and having a free 3′ hydroxyl group can be used for such sequencing.

In embodiments of the present wherein hairpin oligonucleotides are used to capture copies of the target molecule onto the solid support, the primer function may be provided by the 3′ end of the hairpin oligonucleotide following ligation of the 3′ end of the copy of the target nucleic acid molecule to the 5′ end of the hairpin. The nascent chain may then be extended in a stepwise manner by the polymerase reaction.

In a preferred sequencing method each of the different nucleotides (A, T, G and C) incorporates a unique fluorophore and a block at the 3′ position on the nucleotide acts as a blocking group to prevent uncontrolled polymerisation. The polymerase enzyme incorporates a nucleotide into the nascent chain complementary to the strand being sequenced, and the blocking group prevents further incorporation of nucleotides. The array surface is then cleared of unincorporated nucleotides and each incorporated nucleotide is “read” optically by a charge-coupled device using laser excitation and filters. The 3′-blocking group is then removed (deprotected), to expose the nascent chain for further nucleotide incorporation.

U.S. Pat. No. 5,302,509 also discloses another method to sequence polynucleotides immobilised on a solid support. The method relies on the incorporation of fluorescently-labelled, 3′-blocked bases A, G, C and T to the immobilised polynucleotide, in the presence of DNA polymerase. The polymerase incorporates a base complementary to the target polynucleotide, but is prevented from further addition by the 3′-blocking group. The label of the incorporated base can then be determined and the blocking group removed by chemical cleavage to allow further polymerisation to occur.

Other suitable sequencing procedures will be apparent to the skilled person. In particular, the sequencing method may rely on the degradation of the arrayed polynucleotides, the degradation products being characterised to determine the sequence.

An example of a suitable degradation technique is disclosed in WO-A-95/20053, whereby bases on a polynucleotide are removed sequentially, a predetermined number at a time, through the use of labelled adaptors specific for the bases, and a defined exonuclease cleavage.

A consequence of sequencing using non-destructive methods is that it is possible to form a spatially addressable array for further characterisation studies, and therefore non-destructive sequencing may be preferred. In this context, the term “spatially addressable” is used herein to describe how different clusters of molecules may be identified on the basis of their position on an array.

In the case that the target nucleic acid molecules are generated by restriction digest of genomic DNA, the recognition sequence of the restriction or other nuclease enzyme will provide 4, 6, 8 bases or more of known sequence (dependent on the enzyme). However, as aforementioned, adaptor molecules of known sequence can be added to the ends thereof. Further sequencing of between 10 and 20 bases on the array (to give a total sequence read of at least 16 nucleotides) should provide sufficient overall sequence information to place that stretch of DNA into unique context with a total human genome sequence, thus enabling the sequence information to be used for genotyping and more specifically single nucleotide polymorphism (SNP) scoring.

Thus the arrays of this invention may be incorporated into, for example, a sequencing machine or genetic analysis machine.

The clustered arrays immobilised onto the surface of a solid support should be capable of being resolved by optical means. This means that, within the resolvable area of the particular imaging device used, there must be one or more distinct signals, each representing one cluster. Typically, the polynucleotides of the array are resolved using a fluorescence microscope equipped with a sensitive detector, e.g., a charge-coupled device (CCD). Each cluster of the array may be imaged simultaneously or, by scanning the array, a fast sequential analysis can be performed.

The extent of separation between the individual clusters on the array will be determined, in part, by the particular technique used to resolve the cluster. Apparatus used to image molecular arrays are known to those skilled in the art. For example, a confocal scanning microscope may be used to scan the surface of the array with a laser to image directly a fluorophore incorporated on the individual polynucleotide by fluorescence. Alternatively, a sensitive 2-D detector, such as a charge-coupled device, can be used to provide a 2-D image representing the individual polynucleotides on the array

“Resolving” single clusters on the array with a 2-D detector can be done if, at 100× magnification, adjacent clusters are separated by a distance of approximately at least 250 nm, preferably at least 300 nm and more preferably at least 350 nm. It will be appreciated that these distances are dependent on magnification, and that other values can be determined accordingly, by one of ordinary skill in the art.

Other techniques such as scanning near-field optical microscopy (SNOM) are available which are capable of greater optical resolution, thereby permitting more dense arrays to be used. For example, using SNOM, adjacent polynucleotides may be separated by a distance of less than 100 nm, e.g., 10 nm. For a description of scanning near-field optical microscopy, see Moyer et al., Laser Focus World (1993) 29(10).

An additional technique that may be used is surface-specific total internal reflection fluorescence microscopy (TIRFM); see, for example, Vale et al., Nature (1996) 380:451-453). Using this technique, it is possible to achieve wide-field imaging (up to 100 μm×100 μm). This may allow arrays of greater than 10⁷ resolvable clusters per cm² to be used.

Additionally, the techniques of scanning tunnelling microscopy (Binnig et al., Helvetica Physica Acta (1982) 55:726-735) and atomic force microscopy (Hansma et al., Ann. Rev. Biophys. Biomol. Struct (1994) 23:115-139) are suitable for imaging the arrays of the present invention. Other devices which do not rely on microscopy may also be used, provided that they are capable of imaging within discrete areas on a solid support.

Because the array consists of distinct optically resolvable clustered copies of polynucleotides complementary to a target nucleic aid molecule, each target nucleic acid molecule will generate a series of distinct signals as the fluorescent events are detected. Thus the efficiency or stringency levels imposed on each cycle of detection may be reduced as compared to those employed on the use of single molecule arrays.

Non-limiting embodiments of the invention will now be described with reference to the accompanying drawings.

FIG. 1(a) schematically illustrates a vesicle fused to a surface to form an aqueous chamber. The chamber permits coupling chemistry between complementary functionalities on the nucleic acid molecules to be immobilised (e.g. amplified copies of the target molecule) and the surface. Amplification will have taken place within vesicles in solution, prior to contact with the solid surface. In the illustrated embodiment the molecules to be immobilised on the surface bear a phosphorothioate moiety which enables coupling to bromoacetamidopropyl groups on the surface, but any suitable coupling chemistry known in the art could be used. In the illustrated embodiment the nucleic acid molecules to be immobilised are amplified copies of a single template molecule which have been attached to hairpin oligonucleotides. Sequence A′ at the 3′ end of each the amplified copy is complementary to sequence A at the 3′ end of the hairpin oligonucleotide. Sequence B′ derives from the primer used for linear amplification of the template (not shown). A 3′ block is included at the 3′ end of the hairpin oligonucleotide.

FIG. 1(b) schematically illustrates the same surface as shown in 1(a) after coupling has taken place. The 3′ blocks have been removed from the hairpin oligonucleotides to leave free 3′ hydroxyl groups which provide initiation points for single base sequencing of the amplified copy molecules. In a related embodiment the hairpin capture moieties can be laid down on the solid surface prior to contact with vesicles containing copies of the target molecule. Following contact between vesicles and support, the copies within each vesicle may be ligated to hairpins attached to the support, thus forming discrete clusters of clonal copies within each vesicle. The vesicles may then be removed to leave a clustered array ready for interrogation.

FIG. 2 schematically illustrates an embodiment of the invention based on surface dependent amplification. In this embodiment a plurality of first amplification primers complementary to a region of the target molecule to be amplified are bound to the surface of a solid support to form a “lawn” of primers. Other reagents for the amplification are contained within vesicles containing on average a single copy of the template to be amplified, which in this embodiment is a double-stranded nucleic acid molecules, together with an excess of a second amplification primer in free solution within the vesicle. The vesicles are then fused to the surface to create hemispherical aqueous chambers which remain isolated during the remainder of the amplification procedure (step (i)). Fusion of the vesicles to the surface may take place by random fusion or by involve targeting, for example using biotinylated lipids, chemistry or topological features. The target molecule then hybridises with a first amplification primer attached to the surface. Surface amplification within the aqueous chambers created in step (i) using the first primers immobilised on the surface and the second primers in free solution leads to clonal cluster formation. Steps (ii) to (v) schematically illustrate two cycles of extension with intermediate denaturation and hybridisation (annealing) steps. Further cycles of amplification will be performed subsequent to step (v). A post amplification wash is carried out to remove lipophilic materials and unbound products, leaving clonal clusters ready for subsequent applications, such as single base sequencing (part (vi)). Part (vi) is intended as a schematic illustration of the clustered array in which only two individual clusters are shown. Each cluster consists of identical immobilised single strands. The number of strands shown is for illustration only and is not intended as a quantitative representation. Depending on the choice of starting templates, different clusters may consist of strands comprised of a central portion which is of different sequence in each cluster, flanked by sequences common to all clusters, these being derived from the amplification primers. This is possible if the target molecules in each vesicle are all modified by the addition of common adaptor sequences which permit amplification using a “universal” pair of primers.

FIG. 3 schematically illustrates a still further embodiment of the invention. In step 1 DNA clusters are formed by amplification within vesicles (droplets) in solution. The vesicles are loaded with reagents necessary for the amplification reaction, including a DNA template molecule, a polymerase, dNTPS and a primer bearing an acrylamide moiety. In step 2 polymerisation is initiated within the vesicles and the amplified DNA clones are covalently linked in a prepolymer. In step 3 the vesicles containing linked DNA clones are spin-coated or cast on an activated surface bearing covalently attached polymerisable moieties.

The following examples illustrate the invention but are in no way intended to restrict its scope.

### EXAMPLE 1

A sample of genomic DNA purified from a blood is subjected to one of several known methods to fragment it into 500 bp portions. The ends are enzymatically repaired by methods known to those skilled in the art to give blunt ends that are phosphorylated at their 5′ ends. A 100 fold molar excess of a 1000 bp linear, blunt-ended, dephosphorylated vector is added along with 1000 Units of T4 DNA ligase to generate a circular product comprising the vector and a single fragment. The vector is chosen so that the sequences adjacent to either end of the inserted fragment are different and can form sequences for hybridrising PCR primers. The DNA solution is then diluted to a concentration of 10 M in a 200 μl PCR reaction buffer containing 250 μM dNTP's, 10 Units of Taq DNA polymerase and 2 μM each of two primers that hybridise to the vector at either end of the genomic DNA insert. One of the primers contains a 5′ functionality for coupling to a surface, for example a phosphorothioate group. The PCR mix is added dropwise to a rapidly stirring mineral oil blend containing 4.5% (v/v) SPAN 80, 0.4% Tween 80 and 0.05% Triton X100 to form an emulsion with a median drop size of 1 micron. The emulsion thus formed will contain over 99% of the template molecules as single molecules in single drops, as expected from a Poisson distribution. The ‘single molecule’ emulsion is then thermocycled in a PCR machine for 20 cycles to generate more than 10000 copies of the single template per emulsion drop. Amplification of single templates of DNA by a polymerase chain reaction (PCR) in discrete vesicles produced by emulsifying an aqueous PCR mixture in an oil has been reported by Nakano et al. 2003 (J. of Biotechnology, vol 102, pg 117-124).

Following PCR, the emulsion is applied to a glass microscope slide that has been functionalised to react with the phosphorothioate group on the DNA copies. Suitable slides can be produced by derivatization with a mixture of Tetraethoxysilane and Triethoxy-bromoacetamidopropyl-silane in a ratio of 1:100. The slide is incubated for 2 hours at room temperature to allow the aqueous drops to sediment onto the surface of the slide and the DNA to couple to the surface. The slide is then washed sequentially with Xylene, H₂O, a hot solution (95° C.) of 10 mM TrisHCl pH 8 containing 10 mM EDTA, then H₂O. The resulting slide contains clusters of single stranded templates to which a common sequencing primer or hairpin can be annealed (to the 3′ end of the template strand); if a hairpin is used, T4 DNA ligase can be added to covalently attach the hairpin to the single stranded templates.

### EXAMPLE 2

20 μL of a solution of a Cy3™ fluorescent labelled and 5′ functionalised 20mer oligonucleotide (10 μM in 100 mM phosphate buffer pH 7) was emulsified by dropwise addition (10×2 μL aliquots) into 400 μL of an oil phase (1% v/v Span 80 in Mineral oil) under constant stirring. The emulsion was then poured over a glass slide that had been derivatized with a mixture of Tetraethoxysilane and Triethoxy-bromoacetamidopropyl-silane in a ratio of 1:100. The slide was incubated for 40 minutes at room temperature, then washed by vortexing for 20 seconds in a succession of solvents and solutions as follows: Xylene, water, twice with a hot (>85° C.) solution of 10 mM Tris (pH 8) and 10 mM EDTA, water, then finally dried by blowing it with a stream of Argon.

The presence or absence of Cy3™ labelled DNA coupled to the surface of the slide was determined by scanning the slide on a fluorescent microarray scanner (resolution of 50 micron per pixel) FIG. 4 shows the image of a scanned slide incubated with an emulsion of Cy3™ labelled DNA containing a 5′ phosphate group (a negative control). In contrast, FIG. 5 shows the image of a scanned slide incubated with an emulsion of Cy3™ labelled DNA containing a 5′ phosphothioate group. A comparison of the two images indicates successful coupling of DNA from an emulsion of discrete vesicles.

All patents, patent applications, and published references cited herein are hereby incorporated by reference in their entirety. While this invention has been particularly shown and described with references to preferred embodiments, it will be understood by those skilled in the art that various changes in form and details may be made without departing from the scope of the invention encompassed by the claims.

1. A method of producing a clustered array of one or more clonal copies of a single target molecule immobilised on a solid support, each cluster in said array being capable of resolution by optical microscopy, said method comprising providing clonal copies of a single target molecule within a vesicle or on the surface of a solid support within a chamber defined by a vesicle in contact with said solid support to produce clonal copies thereof and immobilising said copies on said solid support.

2. A method according to claim 1 wherein said target molecule is a nucleic acid molecule.

3. A method according to claim 1 which comprises
a) providing a vesicle in contact with the surface of a solid support so as to define a chamber between said support and said vesicle, which chamber comprises a single target molecule including a functionality to effect immobilisation to the surface of said solid support,
b) copying said target molecule on the surface of said support to produce copies of said target molecule forming said cluster.

4. A method according to claim 3 wherein said method comprises the step of first contacting with said support a single target molecule including said functionality to effect immobilisation to the surface of the support and subsequently contacting said vesicle with said support so as to provide a chamber between said support and said vesicle, which chamber comprises said single target molecule.

5. A method according to claim 3, wherein said method first comprises the step of contacting with said solid support a vesicle defining an enclosed chamber therein which chamber comprises therein said single target molecule.

6. A method according to claim 3 wherein said functionality to effect immobilisation to the surface of said solid support is capable of interacting with a complementary capture moiety attached to the surface of said solid support.

7. A method according to claim 6 wherein said single target molecule is a nucleic acid molecule and said functionality to effect immobilisation to the surface of said solid support is a sequence of nucleotides in said nucleic acid molecule capable of hybridising to a nucleotide sequence in a complementary capture moiety which is a polynucleotide molecule attached to the surface of the solid support.

8. A method according to claim 7 wherein the capture moiety is an amplification primer.

9. A method according to claim 8 wherein step b) comprises amplification of the single target nucleic acid molecule using said amplification primer.

10. A method according to claim 9 wherein said amplification is carried out using said amplification primer attached to the surface of the solid support and a second amplification primer in free solution within the chamber defined between said support and said vesicle.

11. A method according to claim 10 wherein said target nucleic acid molecule (in single stranded form) includes a first known adaptor sequence at its 3′ end and a second known adaptor sequence at its 5′ end, wherein the first known adaptor sequence is capable of hybridising to the amplification primer attached to the surface of the solid support and the complement of the second known adaptor sequence is capable of hybridising to the amplification primer present in free solution.

12. A method according to claim 1 comprising,
a) providing at least one vesicle defining an enclosed chamber therein, said chamber including said single target molecule and one or more copies thereof,
b) contacting said vesicle with the surface of a solid support to effect localised immobilisation of said copies of the target molecule to the surface of said support, each of said copies including a functionality to effect said immobilisation to the surface of said solid support.

13. A method according to claim 12 wherein said target molecule is a nucleic acid molecule and said copies of said target molecule are copies produced by nucleic acid amplification inside said vesicle.

14. A method according to claim 12 wherein said copies of said target molecule are capable of being attached to said solid support via a functionality thereon capable of interacting with a complementary capture moiety having means to effect attachment to the surface of said support.

15. A method according to claim 14, wherein said target molecule is a nucleic acid molecule and said capture moiety comprises a nucleic acid molecule comprising a nucleotide sequence that is complementary to a nucleotide sequence on the copies of the target nucleic acid molecule.

16. A method according to claim 15, wherein said target nucleic acid molecule comprises an adaptor molecule of known nucleic acid sequence at one of its 5′ and 3′ ends.

17. A method according to any of claim 15 wherein said target nucleic acid molecule includes an adaptor molecule of known nucleic acid sequence at each of its 5′ and 3′ ends.

18. A method according to claim 17 wherein said amplification step utilises a single primer species specific for said 3′ adaptor molecule to produce a nucleic acid molecule having a sequence complementary to the target nucleic acid molecule.

19. A method according to claim 15 wherein said capture moiety comprises a hairpin oligonucleotide.

20. A method according to claim 19, wherein said hairpin oligonucleotide comprises a sequence its 3′ end corresponding to that of the 5′ adaptor molecule of the target nucleic acid molecule and a 3′ blocking group.

21. A method according to claim 20, wherein said hairpin oligonucleotide is present in the chamber of said vesicle, capture of the complementary copies of said single target molecule occurring prior to the fusion of said vesicle to said solid support.

22. A method according to claim 20, wherein said hairpin oligonucleotide is present on the surface of said support, capture of the complementary copies of said single target molecule occurring subsequent to the contacting of said vesicle with said solid support.

23. A method according to claim 21 wherein said vesicle further comprises a ligase enzyme to ligate the complementary copies of said target molecule to the 5′ end of said hairpin incorporating a phosphate moiety.

24. A method according to claim 1 comprising,
a) providing at least one vesicle defining an enclosed chamber therein and one or more copies of said single target molecule within said vesicle, said vesicle comprising a linking molecule for linking said copies together in said vesicle, and
b) applying said linked copies of said target molecule to a solid surface to form an array of clustered arrays of said copies, said linking molecule comprising a functionality to effect attachment to the surface of said support.

25. A method according to claim 24 wherein said linking molecule comprises a dendrimeric molecule, said one or more copies of said single target molecule being generated by providing on said dendrimeric molecule one or more copies of a single primer species complementary to a nucleotide sequence in the target molecule in the presence of a polymerase and appropriate dNTP molecules.

26. A method according to claim 24 wherein said linking molecule comprises a polymerisation initiator attached to said copies.

27. A method according to claim 1, wherein said vesicle comprises an isolated chamber in a bulk phase, whose interface with the bulk phase prevents exchange of the single target molecule and copies thereof in the aqueous chamber with the bulk phase.

28. A method according to claim 1 wherein said vesicle is formed from droplets of water emulsified in oil.

29. A method according to claim 27 wherein said vesicle is a liposome.

30. A method according to claim 27 wherein said vesicle is formed from a polyelectrolyte nanoshell.

31. A method according to claim 27 wherein said vesicle comprises an aqueous core and/or a shell formed by coacervation.

32. A vesicle for use in producing a clustered array of one or more clonal copies of a single target molecule, said vesicle comprising an enclosed chamber therein comprising either said single target molecule and/or copies thereof or the components to effect copying of said single target molecule or both, and which vesicle is formed from an isolated chamber in a bulk phase, whose interface with the bulk phase prevents exchange of the single target molecule and/or copies thereof with the bulk phase.

33. A vesicle according to claim 32, which vesicle is formed from droplets of water emulsified in oil.

34. A vesicle according to claim 32 which vesicle is a liposome.

35. A vesicle according to claim 32 which is formed from a polyelectrolyte nanoshell.

36. A vesicle according to claim 32 which has an aqueous core and/or a shell formed from coacervation.

37. A vesicle according to claim 32, wherein said single target molecule or copies thereof comprise a functionality capable of interacting with a complementary capture moiety having means to effect immobilisation of said target molecule or copies thereof to the surface of said solid support.

38. A kit for producing a clustered array of one or more clonal copies of a single target molecule which kit comprises a plurality of vesicles according to claim 32 and a solid support for contacting with said vesicles.

39. A kit according to claim 38, wherein said target molecule is a nucleic acid molecule.

40. A kit according to claim 38, wherein said capture moiety comprises a nucleic acid molecule comprising a sequence that is complementary to a sequence on the target nucleic acid molecule or copies thereof.

41. A kit according to claim 38, wherein said target nucleic acid molecule comprises an adaptor molecule of known nucleic acid sequence at one of its 5′ and 3′ ends.

42. A kit according to claim 38 wherein said target nucleic acid molecule includes an adaptor molecule of known nucleic acid sequence at each of its 5′ and 3′ ends.

43. A kit according to claim 42 further comprising a first amplification primer capable of hybridising to said 3′ adaptor molecule and a second amplification primer which is capable of hybridising to the complement of said 5′ adaptor sequence, wherein the first amplification primer includes a functionality which permits attachment to said solid support.

44. A kit according to claim 42 further comprising a single primer species specific for said 3′ adaptor molecule for use in an amplification step to produce a nucleic acid molecule having a sequence complementary to the target nucleic acid molecule.

45. A kit according to claim 38 wherein said capture moiety comprises a hairpin oligonucleotide.

46. A kit according to claim 45, wherein said hairpin oligonucleotide comprises a sequence its 3′ end corresponding to that of the 5′ adaptor molecule of the target nucleic acid molecule and a 3′ blocking group.

47. A kit according to claim 45, wherein said hairpin oligonucleotide is present in the chamber of said vesicle.

48. A kit according to claim 45 wherein said hairpin oligonucleotide is present on the surface of said solid support.

49. A kit according to claim 46 further comprising a ligase enzyme to ligate the 3′ end of the complementary copy of said target molecule to the 5′ end of said hairpin incorporating a phosphate moiety.
